(19) United States
(12) Patent Application Publication
(10) Pub. No.: US 2023/0302667 A1
(43) Pub. Date: Sep. 28, 2023

(54) APPARATUS FOR IMPROVING CLEANLINESS OF ROBOT AND ASSOCIATED ROBOT

(71) Applicant: ABB Schweiz AG, Baden (CH)

(72) Inventor: Xiaodong Cao, Shanghai (CN)

(21) Appl. No.: 18/042,182

(22) PCT Filed: Sep. 7, 2020
(86) PCT No.: PCT/CN2020/113783

§ 371 Date: Feb. 17, 2023

(51) Int. Cl. B25J 19/00; B25J 17/00

(52) U.S. Cl. CPC B25J 19/0079; B25J 17/00

(57) ABSTRACT

Embodiments of an apparatus for improving cleanliness of a robot and an associated robot. The apparatus includes a hoop adapted to be mounted on a joint of the robot to enclose a plurality of parts of the joint, wherein the hoop is shaped such that at least one gap is formed between the hoop and the plurality of parts. A suction port provided on the hoop and adapted to be coupled to a suction device to allow creation of a flow from the at least one gap to the suction port. Within the hoop enclosing the parts of the joint that move relatively and the suction port allowing creation of a flow from the gap to the suction port, debris generated due to the relative movement of the parts during operation of the robot can be removed with the flow.

### FIELD

Embodiments of the present disclosure generally relate to a robot, and more specifically, to an apparatus for improving cleanliness of a robot.

### BACKGROUND

With the booming consumer electronics market, the consumer electronic supply chain with its cleanroom requirements is growing and cleanroom robotics will play a key role in this growth. Cleanrooms are classified according to the number and size of the particles permitted per volume of air. For example, a Class 10 cleanroom denotes that no more than ten particles of 0.5 μm or larger and zero particles of 5.0 μm or larger are permitted per cubic foot of air. Contaminants come from people, processes, facilities, and equipment. In order to control contaminants that are invisible to the human eye, the manufacturing cell and in many cases the entire room must be controlled.

Robots used in this environment must meet stringent cleanroom certification requirements to prevent them from acting as a source of contamination. Much of the hardware used in a cleanroom robot is the same as any other robot with the important exception of a combination of sealed covers to prevent particles from escaping the robot, stainless steel hardware, proper non-gassing lubricants and vacuum to evacuate any internally generated particles. In addition, the food or pharmaceutical industry also has a great demand for cleanroom robots.

### SUMMARY

Embodiments of the present disclosure provide an apparatus for improving cleanliness of a robot and an associated robot to at least in part solve the above and other potential problems.

In a first aspect, an apparatus for improving cleanliness of a robot is provided. The apparatus comprises a hoop adapted to be mounted on a joint of the robot to enclose a plurality of parts of the joint, the plurality of parts can move relatively, wherein the hoop is shaped such that at least one gap is formed between the hoop and the plurality of parts; and a suction port provided on the hoop and adapted to be coupled to a suction device to allow creation of a flow from the at least one gap to the suction port.

Within the hoop enclosing the parts of the joint that move relatively and the suction port allowing creation of a flow from the at least one gap to the suction port, debris generated due to the relative movement of the parts during operation of the robot can be removed with the flow. In this way, the debris will not spread into surrounding environments. As a result, the cleanliness level of the robot can be significantly improved.

In some embodiments, the hoop comprises a plurality of shells coupled to each other to facilitate mounting of the hoop on the joint. In this way, the hoop can be easily mounted on the joint, for example, with suitable fasteners, which improve the mounting efficiency of the hoop on the joint.

In some embodiments, the apparatus further comprises at least one through hole formed on the hoop and adapted for at least one of the plurality of parts to pass through. This arrangement can efficiently avoid possible interferences between the parts and the hoop, thereby improving the reliability of the robot.

In some embodiments, the plurality of shells are coupled to each other by at least one of a snap connection, fasteners, or an adhesive. This arrangement can improve flexibility for mounting of the hoop on the joint.

In some embodiments, the apparatus further comprises at least one connection plate arranged adjacent to ends of the plurality of shells to connect the plurality of shells. This arrangement can facilitate mounting of the hoop on the joint, thereby improving mounting efficiency of the apparatus.

In some embodiments, the hoop is arranged to move with one of the plurality of parts. As a result, the cleanliness level of the robot can be significantly improved without changing an existing motion mode of the robot.

In some embodiments, the hoop is coaxial with one of the plurality of parts and adapted to rotate with the other of the plurality of parts about an axis of the hoop.

In some embodiments, the apparatus further comprises a positioning rib protruding inward from an inner surface of the hoop and adapted to fit in one of the plurality of parts to facilitate positioning of the hoop on the joint. This arrangement can ensure that the hoop is quickly mounted in a proper location.

In a second aspect, a robot is provided. The robot comprises at least one joint and at least one apparatus according to the first aspect as mentioned above.

It is to be understood that the Summary is not intended to identify key or essential features of embodiments of the present disclosure, nor is it intended to be used to limit the scope of the present disclosure. Other features of the present disclosure will become readily comprehensible through the description below.

### BRIEF DESCRIPTION OF THE DRAWINGS

The above and other objectives, features and advantages of the present disclosure will become more apparent through more detailed depiction of example embodiments of the present disclosure in conjunction with the accompanying drawings, wherein in the example embodiments of the present disclosure, the same reference numerals usually represent the same components.

FIG. 1 shows perspective views of a joint of a robot and an apparatus before and after being assembled together according to embodiments of the present disclosure;

FIG. 2 shows a perspective view of an apparatus according to embodiments of the present disclosure;

FIG. 3 shows a perspective view of an apparatus according to further embodiments of the present disclosure;

FIG. 4 shows a front cross-sectional view of a joint with an apparatus according to embodiments of the present disclosure;

FIG. 5 shows a top cross-sectional view of a joint with an apparatus according to embodiments of the present disclosure;

FIG. 6 shows an enlarged view of part A of the joint with an apparatus as shown in FIG. 5 according to embodiments of the present disclosure;

FIG. 7 shows a side cross-sectional view of a joint with an apparatus according to embodiments of the present disclosure; and

FIG. 8 shows an enlarged view of part B of the joint with an apparatus as shown in FIG. 7 according to embodiments of the present disclosure.

Throughout the drawings, the same or similar reference symbols are used to indicate the same or similar elements.

### DETAILED DESCRIPTION

The present disclosure will now be discussed with reference to several example embodiments. It is to be understood these embodiments are discussed only for the purpose of enabling those persons of ordinary skill in the art to better understand and thus implement the present disclosure, rather than suggesting any limitations on the scope of the subject matter.

As used herein, the term “comprises” and its variants are to be read as open terms that mean “comprises, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be comprised below. A definition of a term is consistent throughout the description unless the context clearly indicates otherwise.

As mentioned above, some industries such as the food, pharmaceutical or consumer electronics industries have strict requirements on the cleanliness of robots. A manufacturing cleanroom is an environment having controlled levels of airborne particles, dust, vapor and moisture. Specialized cleanroom robots are commonly used in these areas to reduce any additional contamination and are required to meet specific cleanroom standards.

Robots, especially joints of robots, may generate debris or particles due to friction between relatively moving parts of the joints, which constitute a major source of contamination generated by robots. That is, most of the contaminations generated by robots come from parts of the joint that move relatively. In order for the robot to meet stringent cleanliness standards, it is necessary to solve the problem of how to prevent contamination from escaping from these parts.

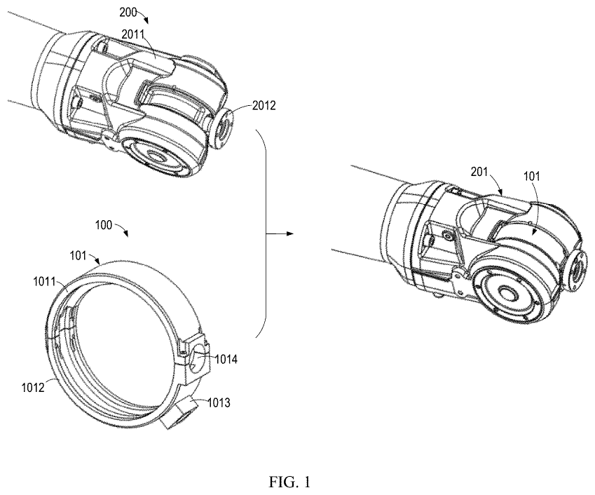

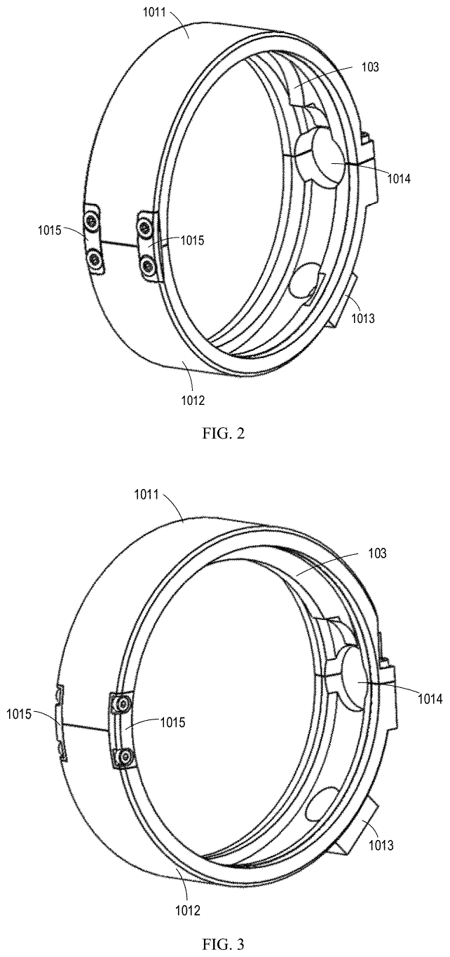

In order to at least partially address the above and other potential problems, embodiments of the present disclosure provide an apparatus for improving the cleanliness of a robot. FIG. 1 shows perspective views of a joint 201 of a robot 200 and an apparatus 100 before and after being assembled together; FIG. 2 shows a perspective view of the apparatus 100; and FIG. 3 shows a perspective view of the apparatus 100 according to further embodiments of the present disclosure.

As shown in FIGS. 1-3, generally, the apparatus 100 according to embodiments of the present application comprises a hoop 101 and a suction port 1013 provided on the hoop 101. The hoop 101 is adapted to be mounted on a joint 201 of a robot 200 to enclose a plurality of parts 2011, 2012 of the joint 201 which can move relatively. Although FIGS. 1-3 show as examples that the hoop 101 has a generally ring-shaped, it is to be understood that the hoop 101 can have any suitable shape to match the shape of the robot and/or its joints. For example, in some alternative embodiments, the hoop 101 can be of a square frame shape, a triangular shape, a trapezoidal shape or any other suitable shape. The hoop with various appropriate shapes can be applied to various robots, which comprise existing robots or newly developed robots, to improve the cleanliness level of the robots.

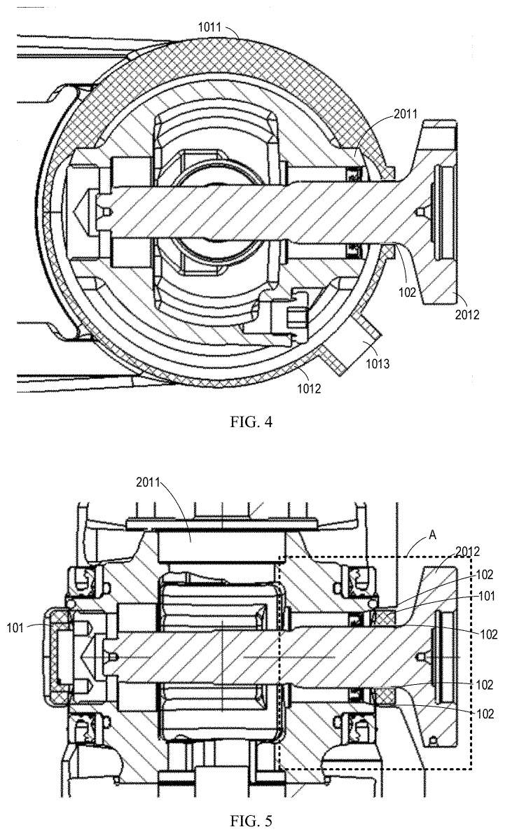

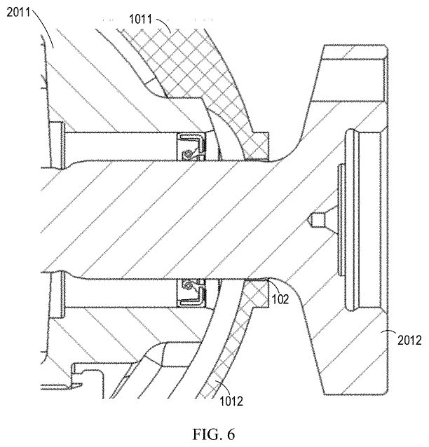

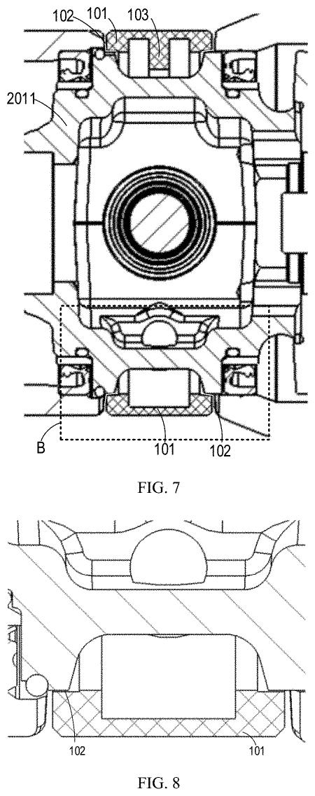

Furthermore, the hoop 101 is shaped to form at least one gap 102 between the hoop 101 and the plurality of parts 2011, 2012, as shown in FIG. 4. For example, in some embodiments, the gaps 102 may be formed between circumferential edges and ends of the hoop 101 and the parts 2011, 2012, as shown in FIGS. 5-8. These omnidirectional gaps can remove debris or particles more comprehensively. Of course, locations of the gaps 102 may also be varied. For example, in some alternative embodiments, the gaps 102 may also be formed between the portions of the parts 2011, 2012 prone to debris or particles and the corresponding portions of the hoop 101, which can improve the effect of removing debris or particles.

The suction port 1013 can be coupled to a suction device such as a vacuum pump. With operation of the suction devices, a flow from the at least one gap 102 to the suction port 1013 can be created. The flow can take away debris or particles generated by the parts 2011, 2012 and prevent them from escaping to surrounding environments. In this way, the cleanliness of the robot 200 can be significantly improved.

In some embodiments, a width of at least one gap 102 is within a threshold range, for example, between 0.05 mm and 0.8 mm, to improve the suction effect of debris or particles. The width of the at least one gap 102 means a minimum distance from the hoop 101 to any of the parts 2011, 2012. In some embodiments, the distance from the hoop 101 to any of the parts 2011, 2012 along the gap 102 may be constant. That is, the width of the gap 102 can be constant. Alternatively or additionally, in some embodiments, the width of the gap 102 may be changed in a direction from outside to inside of a cavity formed by the hoop 101. For example, the width of the gap 102 may be gradually reduced from outside to inside of the cavity to create a stronger flow. In this way, debris or particles can be removed more efficiently.

It should be understood that the above embodiments about the gap 102 are merely for illustrative purposes, without suggesting any limitation as to the scope of the present disclosure. Any suitable form of the gap is also possible. For example, in some alternative embodiments, a width of the gap 102 may be changed periodically along the gap 102 to reduce possible disturbance of the flow.

In some embodiments, to facilitate mounting of the hoop 101 on the joint 201, the hoop 101 may comprise a plurality of shells 1011, 1012, as shown in FIGS. 2-4. As an example, FIGS. 2-4 show that the hoop 101 may comprise two shells, each equivalent to a half ring. The shells 1011, 1012 can be coupled to each other to form the hoop 101. In this way, the hoop 101 can be mounted on the joint 201 easily by coupling the shells 1011, 1012.

It should be understood that the above embodiments where the hoop 101 comprises two shells 1011, 1012 as shown in FIGS. 2-4 are merely for illustrative purposes, without suggesting any limitation as to the scope of the present disclosure. Any other structure or arrangement may also be possible. For example, in some alternative embodiments, three or more shells may also be included. Furthermore, in some further alternative embodiments, the hoop 101 may also comprise shells separated in a circumferential direction. This arrangement may be suitable for certain joints in order to improve the assembly efficiency of the apparatus 100 on these joints. In the following, the structure of hoop 101 as shown in FIGS. 2-4 will be mainly discussed as an example to describe other improvements of the apparatus 100.

In some embodiments, the shells 1011, 1012 may be coupled to each other by suitable means, for example, by a snap connection, fasteners, and/or an adhesive. As shown in FIGS. 2 and 3, the shells 1011, 1012 may be coupled to each other by fasteners. For example, in some embodiments, ends of the shells 1011, 1012 may be provided with protrusions and holes formed on the protrusions. The holes on the ends of the shells 1011, 1012 are aligned to each other to allow a fastener to pass through. In this way, the shells 1011, 1012 can be coupled to each other with the fasteners.

Alternatively or additionally, in some embodiments, the apparatus 100 may also comprise at least one connection plate 1015 arranged adjacent to ends of the shells 1011, 1012. For example, the connection plate 1015 can be arranged in a concave formed at or adjacent to ends of the shells 1011, 1012. With the aid of fasteners and the connection plate 1015, the shells 1011, 1012 can be coupled to each other. To facilitate the engagement of the fasteners in the hoop 101, the fasteners may be inserted in corresponding holes radially or axially, as shown in FIGS. 2 and 3.

For example, in some embodiments, when it is difficult to insert the fasteners radially due to the occlusion of other components, the fastener may be engaged in thread holes axially, as shown in FIG. 3, and vice versa. Accordingly, it ensures that the shells can be easily coupled together.

In some embodiments, at least one through hole 1014 may be formed on the hoop 101 and adapted for the at least one of the parts 2011, 2012 to pass through. Although FIGS. 2-3 show as examples that one through hole 1014 is formed at ends of the shells 1011, 1012, it is to be understood that the number and location of the at least one hole 1014 may be varied according to various parts of the joint to be mounted. For example, one or more through holes 1014 may also be formed on any one or both of the shells 1011, 1012.

In some embodiments, the hoop 101 may be arranged to move with one of the parts 2011, 2012. For example, as shown in FIG. 1, the hoop 101 is coaxial to the part 2011 and adapted to rotate with the part 2012 of the joint 201 about an axis of the hoop 101. As a result, the cleanliness level of the robot can be significantly improved by using the apparatus 100 without changing the existing motion mode of the robot.

To facilitate positioning of the hoop 101 on the joint 201, in some embodiments, the apparatus 100 may also comprise a positioning rib 103, as shown in FIGS. 2 and 3. The positioning rib 103 protrudes inward from an inner surface of the hoop 101 and can fit in one of the parts 2011, 2012. For example, the positioning rib 103 may be formed on a position of the inner surface corresponding to an existing groove of one of the parts 2011, 2012. In this way, by means of the positioning rib 103 fitting in the existing groove and without changing structures of the existing joint, the hoop 101 can be duly positioned and mounted on the joint 201. As a result, the mounting efficiency can be improved.

According to other aspects of the present application, a robot is provided. The robot comprises at least one joint 201 and at least one apparatus 100 as mentioned above. With the apparatus 100 according to embodiments of the present disclosure, the cleanliness level of the robot can be significantly improved to meet various cleanroom standards.

It should be appreciated that the above detailed embodiments of the present disclosure are only to exemplify or explain principles of the present disclosure and not to limit the present disclosure. Therefore, any modifications, equivalent alternatives and improvements, etc. without departing from the spirit and scope of the present disclosure shall be comprised in the scope of protection of the present disclosure. Meanwhile, appended claims of the present disclosure aim to cover all the variations and modifications falling under the scope and boundary of the claims or equivalents of the scope and boundary.

1. An apparatus for improving cleanliness of a robot, comprising:
a hoop adapted to be mounted on a joint of the robot to enclose a plurality of parts of the joint, the plurality of parts can move relatively, wherein the hoop is shaped such that at least one gap is formed between the hoop and the plurality of parts; and
a suction port provided on the hoop and adapted to be coupled to a suction device to allow creation of a flow from the at least one gap to the suction port.

2. The apparatus of claim 1, wherein the hoop comprises:
a plurality of shells coupled to each other to facilitate mounting of the hoop on the joint.

3. The apparatus of claim 1, further comprising:
at least one through hole formed on the hoop and adapted for at least one of the plurality of parts to pass through.

4. The apparatus of claim 2, wherein the plurality of shells are coupled to each other by at least one of a snap connection, fasteners, or an adhesive.

5. The apparatus of claim 4, further comprising:
at least one connection plate arranged adjacent to ends of the plurality of shells to connect the plurality of shells.

6. The apparatus of claim 1, wherein the hoop is arranged to move with one of the plurality of parts.

7. The apparatus of claim 6, wherein the hoop is coaxial with one of the plurality of parts and adapted to rotate with the other of the plurality of parts about an axis of the hoop.

8. The apparatus of claim 1, further comprising:
a positioning rib protruding inward from an inner surface of the hoop and adapted to fit in one of the plurality of parts to facilitate positioning of the hoop on the joint.

9. The apparatus of any of claim 1, wherein the hoop is of a ring shape. The apparatus of any of claim 1, wherein

10. A robot, comprising:
at least one joint; and
at least one apparatus of claim 1 arranged on the at least one joint.

11. The apparatus of claim 2, wherein the hoop is arranged to move with one of the plurality of parts.

12. The apparatus of claim 3, wherein the hoop is arranged to move with one of the plurality of parts.

13. The apparatus of claim 4, wherein the hoop is arranged to move with one of the plurality of parts.

14. The apparatus of claim 5, wherein the hoop is arranged to move with one of the plurality of parts.

15. The apparatus of claim 2, further comprising:
a positioning rib protruding inward from an inner surface of the hoop and adapted to fit in one of the plurality of parts to facilitate positioning of the hoop on the joint.

16. The apparatus of claim 3, further comprising:
a positioning rib protruding inward from an inner surface of the hoop and adapted to fit in one of the plurality of parts to facilitate positioning of the hoop on the joint.

17. The apparatus of claim 4, further comprising:
a positioning rib protruding inward from an inner surface of the hoop and adapted to fit in one of the plurality of parts to facilitate positioning of the hoop on the joint.

18. The apparatus of claim 5, further comprising:
a positioning rib protruding inward from an inner surface of the hoop and adapted to fit in one of the plurality of parts to facilitate positioning of the hoop on the joint.

19. The apparatus of claim 7, further comprising:
a positioning rib protruding inward from an inner surface of the hoop and adapted to fit in one of the plurality of parts to facilitate positioning of the hoop on the joint.

20. The apparatus of any of claim 2, wherein the hoop is of a ring shape.
